(19) United States
(12) Patent Application Publication
(10) Pub. No.: US 2010/0033297 A1
(43) Pub. Date: Feb. 11, 2010

(54) LAYERED BOARD STRUCTURE

(75) Inventor: Juha Patovirta, Hollola (FI)

Correspondence Address: MERCHANT & GOULD PC, P.O. BOX 2903, MINNEAPOLIS, MN, 55402-0903, US

(73) Assignee: UPM RAFLATAC OY, Tampere (FI)

(21) Appl. No.: 12/441,860

(22) PCT Filed: Sep. 19, 2007
(86) PCT No.: PCT/FI07/50497

§ 371 Date: Oct. 1, 2009

(30) Foreign Application Priority Data
Sep. 19, 2006 (FI) 020060381

(51) Int. Cl. G05B 19/00; B32B 37/00; B32B 21/04

(52) U.S. Cl. 340/5.1; 428/537.1; 156/60

(57) ABSTRACT

The invention relates to a layered board structure, which comprises at least two or more veneer layers, which are joined to one another by means of adhesive. In accordance with the invention, the layered board structure comprises further at least one intelligent identifier, which is arranged between said two veneer layers of the layered board structure.

### FIELD OF THE INVENTION

The invention relates to a wood board as defined in the preamble of claim 1, which is formed of several veneer layers, which are joined to one another by means of adhesive. Attached to the wood board is an intelligent identifier.

### BACKGROUND OF THE INVENTION

Known from prior art are various wood boards, e.g. plywoods, veneer boards or the like.

Known from prior art is the gluing of different types of adhesive labels or product specifications onto the surface of the wood board in a separate working phase to provide product information. The problem with adhesive labels attached to the surface is their easy detachment due to variations in temperature and humidity.

Furthermore, known from prior art are different types of intelligent adhesive labels and intelligent identifiers for use in conjunction with different types of products to express the desired product information. Intelligent identifiers can normally be read remotely by means of a reader device.

The attachment of the intelligent identifier substantially to a wood board is not known from prior art.

### OBJECTIVE OF THE INVENTION

The objective of the invention is to eliminate the drawbacks referred to above. Specifically, the objective of the invention is to disclose the attachment of an intelligent identifier to a wood board using a new type of solution.

### SUMMARY OF THE INVENTION

A wood board according to the invention is characterized by what is presented in the claims.

The invention is based on a wood board formed of several layers, which are joined to one another by means of adhesive. In accordance with the invention, the wood board comprises at least one or more intelligent identifiers arranged between two layers of the wood board.

In one embodiment of the invention, the wood board is formed of veneer layers, and the intelligent identifier is arranged between veneer layers of the wood board. In one embodiment, the intelligent identifier is arranged on a glue line between veneer layers.

In one embodiment of the invention, the wood board is formed of veneer layers and coating layer arranged thereupon, and the intelligent identifier is arranged between the first veneer layer and the coating layer of the wood board. In one embodiment, the intelligent identifier is arranged on the glue line between the veneer layer and the coating layer. Preferably, the coating layer is arranged on top of the veneer layers using so-called cold gluing without applying heat or heating.

As used herein, wood board refers to any wood board product, plywood product, composite product, beam, pressed board product or the like composed of separate layers, preferably veneer layers, which are mainly formed of wood-based materials and in whose separate layers are stacked one on top of the other and are glued to one another.

As used herein, veneer layer refers to any layer of material, normally a thin layer of material, which is used in the formation of a layered board. The layer of material can be formed of a wood-based material or other material suitable for the application.

As used herein, intelligent identifier refers to any product information equipment, product identifier or chip, in which the manufacturer or customer can store any information regarding the product and/or using which some characteristic of the product can be measured or monitored. The intelligent identifier can store more comprehensive product information or alternatively only the product identifier or ID-number of the product. The intelligent identifier is preferably capable of being read remotely, and its information can under certain circumstances be modified either directly within the intelligent identifier or by a separate information system that recognizes the product on the basis of the product identifier within the product. Preferably, the intelligent identifier is very thin so as to be unnoticeably arranged between the veneer layers.

In a preferred embodiment, the layers of the wood board are stacked on top of one another and adhesive is arranged in between the layers. The intelligent identifier is arranged inside the product formed by these layers, between layers, in conjunction with production of the wood board and, specifically, in conjunction with the stacking and gluing of the layers.

The stacking of the layers, gluing them to one another and other normal stages of wood board production can be done by means known per se in the art.

In a preferred embodiment of the invention, such an intelligent identifier is selected that can withstand wood board production conditions, preferably a temperature of more than 100° C. and a pressure of more than 1.6 MPa.

In one embodiment of the invention, an intelligent identifier is arranged in the wood board under the first layer, either the veneer or coating layer, near to the upper surface or lower surface of the board. In this case, the intelligent identifier is protected from mechanical damage, but the layer on top of the intelligent identifier is thin, wherein the reading distance of the intelligent identifier is as long as possible. In an alternative embodiment, the intelligent identifier can be arranged anywhere between the layers.

In one embodiment of the invention, an intelligent identifier having an RFID identification circuit is used, e.g. an RFID transponder, RFID inlay, etc. The RFID identifier may comprise a sensor.

In one embodiment, an intelligent identifier is used, which can function as a measurer of information or characteristics and/or as a collector measuring some product characteristic, such as moistness, load or the like. In one embodiment, desired product information can be stored within the intelligent identifier and, further, the intelligent identifier can function as a measurer of characteristics.

In one embodiment, an intelligent identifier is used, whose information can be modified after production of the wood board when the intelligent identifier is located within the wood board.

The intelligent identifier is located at the desired site within the board. In one preferred embodiment, the intelligent identifier is located in the middle of the board.

In one embodiment, as the adhesive between the veneer layers is used liquid phenolic resin or its derivative which is water-soluble. For gluing is preferably used thermosetting phenolic resin.

In one embodiment, polyurethane adhesive is used for gluing the coating layer on top of the veneer layers.

In one embodiment, the intelligent identifier can be coated with a compound or polymer or other coating appropriate for the purpose. In one embodiment, the intelligent identifier is coated with poly-amide, e.g. nylon to improve the strength of the glue line at the location site of the intelligent identifier.

A wood board according to the invention can comprise veneer layers of different thickness. The thicknesses of the veneer layers can vary. The veneer layers can be arranged in the desired position, i.e. crosswise or lengthwise in the desired order.

By using the invention, to a wood board can be added desired remotely readable product information in accordance to the desires of a customer or user. The desired product information travels with board all the time. By using the invention, wood boards can later be identified and connected to a certain production. To the intelligent identifier can be added information important to the customer or user, such as production information or instructions for use.

An advantage of the invention is that the intelligent identifier can be added as a part of the sandwich-type wood board, between layers, already at the production stage of the wood board, wherein separate work stages are not required. By using the invention, the intelligent identifier within the wood board is protected from mechanical damage and wear. Furthermore, an intelligent identifier arranged within a wood board cannot be removed without breaking the board.

By using the invention, a wood board is provided that has many applications, for example, in automated warehouse management; in conjunction with system matrices and ingot base-plates, whose circulation time and service life must be monitored; as scaffolding level boards, from which an exact production date must be found; and in conjunction with punches, wherein it can be read for what purpose the punch was made and how many units have been produced using it.

### LIST OF FIGURES

In the following, the invention is described by means of detailed embodiment examples with reference to accompanying FIGS. 1 and 2, in which

FIG. 1 shows a plywood according to the invention, in which the intelligent identifier is arranged between the veneer layers, and

FIG. 2 shows another plywood according to the invention, in which the intelligent identifier is arranged between the veneer layer and the coating layer.

### DETAILED DESCRIPTION OF THE INVENTION

The intelligent identifiers used in the examples were RFID transponders by Rafsec. In the tests of the example, the intelligent identifiers were placed at the predetermined sites in the plywood in conjunction with, production of the plywood. After production of the plywood, it was tested whether the intelligent identifiers placed in the plywood remained operational.

### Example 1

In this test, placement of intelligent identifiers on the surface of the plywood by hot-pressing under the formed surface layer was examined.

A 600 mm×600 mm birch plywood sample having a thickness of 12 mm was produced. The birch plywood was coated by hot-pressing 120 g/m² with polyphenol, onto which 4 intelligent identifiers were placed. A 120 g/m² polyphenol coating was also arranged on top of the intelligent identifiers by hot-pressing. The production conditions for the plywood were as follows: pressing temperature 130° C., pressure 1.6 MPa and time 7 min.

Based on the test, it could be observed that an intelligent identifier does not remain operational when it is attached to the thermosetting coating of the plywood by hot-pressing.

### Example 2

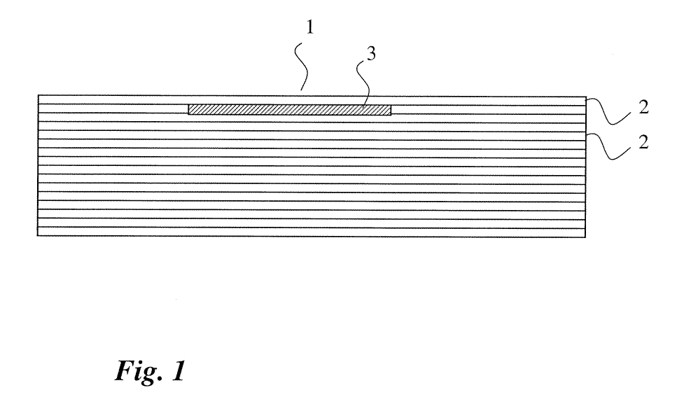

In this test, placement of intelligent identifiers 3 on the glue line between the veneer layers 2 of the plywood was examined (FIG. 1).

A 600 mm×600 mm birch plywood sample having a thickness of 12 mm was produced. The birch plywood was formed of 1.5 mm thick veneers 2, which were joined to one another by gluing with liquid phenolic resin adhesive. 4 intelligent identifiers 3 were placed between the topmost veneer layers 2 by gluing them to the glue line. The production conditions were as follows: pressing temperature 130° C., pressure 1.6 MPa and time 12 min.

Based on the test, it could be observed that an intelligent identifier remains operational when it is attached to the glue line between veneers.

### Example 3

In this test, placement of intelligent identifiers on the glue line between the veneer layers of the plywood when the plywood was additionally coated was examined.

A 600 mm×600 mm birch plywood sample having a thickness of 12 mm was produced. The birch plywood was formed of 1.5 mm thick veneers, which were joined to one another by gluing with liquid phenolic resin adhesive. 4 intelligent identifiers were placed between the topmost veneer layers by gluing them to the glue line. The plywood formed was coated with 120 g/m² polyphenol coating by hot-pressing. The production conditions were as follows: In the production of the plywood the pressing temperature was 130° C., pressure 1.6 MPa and time 12 min; and in the coating process the pressing temperature was 130° C., pressure 1.4 MPa and time 6 min.

Based on the test, it could be observed that an intelligent identifier remains operational when it is attached to the glue line between veneers in conjunction with coated plywood.

### Example 4

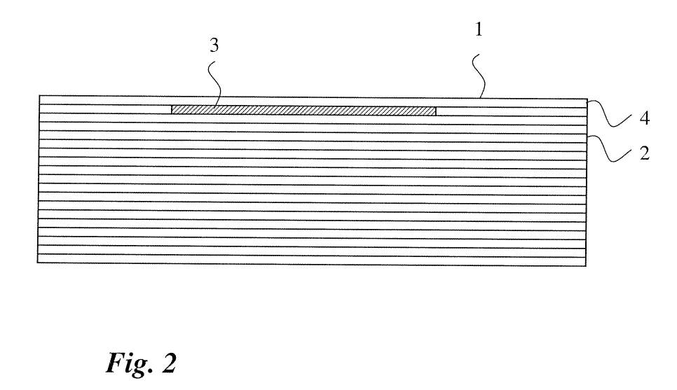

In this test, placement of intelligent identifiers 3 on the surface of the plywood under the surface layer 4 was examined (FIG. 2).

A 600 mm×600 mm birch plywood sample having a thickness of 12 mm was produced. The birch plywood was formed from 1.5 mm thick veneers 2, which were joined to one another by gluing with liquid phenolic resin adhesive. 4 intelligent identifiers 3 were placed on top of the topmost veneer layer 2. A poly-propylene coating 4 was glued on top of the intelligent identifiers 3 using polyurethane adhesive by means of so-called cold gluing. In the coating process, neither heat nor significant pressure was used. After application of the adhesive and the coating, the board was run through the roller that pressed the coating 4 onto the board.

Based on the test, it could be observed that an intelligent identifier remains operational when it is attached to the surface of the plywood under a cold-glued coating 4, between the coating 4 and the topmost veneer layer 2.

Based on the tests conducted, it can be concluded that the best site for an intelligent identifier is on the glue line between the layers of a wood board, wherein it is protected from mechanical damage and wear.

A wood board according to the invention is suitable in its different embodiments for different types of applications.

The embodiments of the invention are not limited to the examples presented rather many variations are possible within the scope of the accompanying claims.

1.-9. (canceled)

10. A layered board structure, which comprises at least two or more veneer layers, which are joined to one another by means of adhesive, wherein the layered board structure comprises further at least one intelligent identifier, which is arranged between said two veneer layers of the layered board structure.

11. A layered board structure according to claim 1, wherein the intelligent identifier is arranged on the glue line between the veneer layers.

12. A layered board structure according to claim 1, wherein the intelligent identifier is attached to the layered board structure substantially in conjunction with its production.

13. A layered board structure according to claim 1, wherein the intelligent identifier is made of a material that can withstand a temperature of more than 100° C. and a pressure of more than 1.6 MPa.

14. A layered board structure according to claim 1, wherein the intelligent identifier is arranged in the layered board structure under the first veneer layer.

15. A layered board structure according to claim 1, wherein the intelligent identifier has an RFID identification circuit.

16. A manufacturing method comprising at least the step of joining two or more veneer layers to one another by means of adhesive to form a layered board structure, wherein the method comprises further step of arranging at least one intelligent identifier between said two veneer layers of the layered board structure.
